(19) United States
(12) Patent Application Publication
(10) Pub. No.: US 2012/0250850 A1
(43) Pub. Date: Oct. 4, 2012

(54) CALL PROCESSING METHOD, APPARATUS AND SYSTEM

(75) Inventors: Naifeng ZHUANG, Shenzhen (CN); Sining WEI, Shenzhen (CN); Wei HUANG, Shenzhen (CN)

(73) Assignee: HUAWEI TECHNOLOGIES CO., LTD., Shenzhen (CN)

(21) Appl. No.: 13/488,098

(22) Filed: Jun. 4, 2012

Related U.S. Application Data
(63) Continuation of application No. PCT/CN2011/072405, filed on Apr. 2, 2011.

(30) Foreign Application Priority Data
Apr. 21, 2010 (CN) 201010156348.1

(51) Int. Cl. H04M 3/00

(52) U.S. Cl. 379/265.12

(57) ABSTRACT

Embodiments of the present invention provide a call processing method, apparatus and system. According to the embodiments of the present invention, under the precondition that the target put-through rate of the alternative skill queue is ensured, all call skill queues are dynamically adjusted. Therefore, according to the embodiments of the present invention, the operator may be taken full advantage of to improve quality of service of all call skill queues.

### CROSS-REFERENCE TO RELATED APPLICATIONS

This application is a continuation of International Application No. PCT/CN2011/072405, filed on Apr. 2, 2011, which claims priority to Chinese Patent Application No. 201010156348.1, filed on Apr. 21, 2010, both of which are hereby incorporated by reference in their entireties.

### FIELD OF THE INVENTION

The present invention relates to the field of communication, and in particular, to a call processing method, apparatus and system.

### BACKGROUND OF THE INVENTION

Service modes of a call center (Call Center, hereinafter referred to as “CC”) may be classified into an interactive voice response (Interactive Voice Response, hereinafter referred to as “IVR”) self service and an operator service. In the operator service, an operator receives a call from a customer, and processes services, including service query, service handling and complaining/advising, for the customer. A call volume of a call center is very large while the number of operators is very limited, therefore during a service peak period, it often occurs that calls cannot be put through, which causes dissatisfaction and frustration of the customer.

In order to ensure that limited operator service resources can serve high-value customers preferentially, and ensure a put-through rate of the high-value customers, the CC in the conventional art employs a call underflow method. Specifically, through setting different skill queues, the CC achieves matching relationships between customers with different values and operators that process the skill queues. The CC may set different target put-through rates for skill queues of customers with different values and a target skill queue for underflow. For example, a 15-second put-through rate of a gold card customer skill queue is 95%, a 15-second put-through rate of a silver card customer skill queue is 85%, and a 15-second put-through rate of an ordinary customer skill queue is 70%. Then, the CC may monitor a status of the put-through rate of each skill queue, compares the put-through rate with the set target put-through rate of the skill queue, does not perform any processing if a current put-through rate is greater than or equal to the target put-through rate; and if the current put-through rate is smaller than the target put-through rate, underflows a call from an in-queue gold card customer in a current queue to a preset target skill queue, where the call from the in-queue gold card customer in the current queue queues preferentially in the skill queue for underflow. For example, if a current put-through rate of the gold card customer skill queue is 90%, which is lower than the target put-through rate, the CC may underflow a call from an in-queue gold card customer in the gold card customer skill queue into the silver card customer skill queue, where the call from the in-queue gold card customer in the gold card customer skill queue queues preferentially in the silver card customer skill queue.

When the put-through rate of the high-value customers is ensured, a put-through rate of customers of a lower value decreases accordingly, thus deteriorating quality of service of the customers of the lower value.

### SUMMARY OF THE INVENTION

Embodiments of the present invention provide a call processing method, apparatus and system, so as to increase a put-through rate of customers of a lower value and improve quality of service of the customers of the lower value on the basis of ensuring a put-through rate of high-value customers.

An embodiment of the present invention provides a call processing method, including:

obtaining, by a call processing apparatus, identifier information of a call skill queue whose call put-through rate is smaller than a preset target put-through rate; and

adjusting, by the call processing apparatus, a first operating authority identifier in an alternative skill queue corresponding to the identifier information to a second operating authority identifier, where the first operating authority identifier is an operating authority identifier of a remaining free operator of the alternative skill queue on the basis of ensuring the target put-through rate, and the second operating authority identifier is an operating authority identifier that can process the call skill queue.

An embodiment of the present invention provides a call processing apparatus, including:

an obtaining module, configured to obtain identifier information of a call skill queue whose call put-through rate is smaller than a preset target put-through rate; and

a processing module, configured to adjust a first operating authority identifier of a free operator in the alternative skill queue corresponding to the identifier information to a second operating authority identifier, where the first operating authority identifier is an operating authority identifier of a remaining free operator of the alternative skill queue on the basis of ensuring the target put-through rate, and the second operating authority identifier is an operating authority identifier that can process the call skill queue.

An embodiment of the present invention provides a call service processing system, including a call center service platform and a call processing apparatus, where

the call center service platform is configured to employ a call skill queue to perform service processing on a call; and

the call processing apparatus is configured to obtain identifier information of a call skill queue whose call put-through rate is smaller than a preset target put-through rate, and adjust a first operating authority identifier in an alternative skill queue corresponding to the identifier information to a second operating authority identifier; where the first operating authority identifier is an operating authority identifier of a remaining free operator of the alternative skill queue on the basis of ensuring the target put-through rate, and the second operating authority identifier is an operating authority identifier that can process the call skill queue.

In the embodiments of the present invention, a corresponding alternative skill queue may be preset for each call skill queue. When a call put-through rate of a call skill queue is smaller than a preset target put-through rate, a first operating authority identifier in the alternative skill queue may be adjusted to a second operating authority identifier, so that an operator corresponding to the adjusted operating authority identifier can listen to the call put-through rate of the call skill queue currently required to be adjusted, and the call put-through rate of the alternative skill queue is not affected. In the embodiments of the present invention, a call skill queue of high-value customers and that of customers of a lower value do not need to be distinguished, and instead, under the precondition that the target put-through rate of the alternative skill queue is ensured, all call skill queues are dynamically adjusted. Therefore, according to the embodiments of the present invention, the operator may be taken full advantage of to improve quality of service of all call skill queues.

### BRIEF DESCRIPTION OF THE DRAWINGS

To illustrate the technical solutions according to the embodiments of the present invention or in the prior art more clearly, accompanying drawings required for describing the embodiments or the prior art are introduced briefly in the following. Apparently, the accompanying drawings in the following description are only some embodiments of the present invention, and persons of ordinary skill in the art may further obtain other drawings from the accompanying drawings without creative efforts.

FIG. 1 is a flow chart of an embodiment of a call processing method according to the present invention;

FIG. 2 is a flow chart of another embodiment of the call processing method according to the present invention;

FIG. 3 is a flow chart of another embodiment of the call processing method according to the present invention;

FIG. 4 is a schematic structural diagram of an embodiment of a call processing apparatus according to the present invention;

FIG. 5 is a schematic structural diagram of another embodiment of the call processing apparatus according to the present invention;

FIG. 6 is a schematic structural diagram of another embodiment of the call processing apparatus according to the present invention; and

FIG. 7 is a schematic structural diagram of an embodiment of a call service processing system according to the present invention.

### DETAILED DESCRIPTION OF THE EMBODIMENTS

To make the objectives, technical solutions and advantages according to the embodiments of the present invention more clearly, the technical solutions according to the embodiments of the present invention are clearly and completely described in the following with reference to the accompanying drawings in the embodiments of the present invention. Obviously, the embodiments to be described are only part of rather than all of the embodiments of the present invention. All other embodiments obtained by persons of ordinary skill in the art based on the embodiments of the present invention without creative efforts shall fall within the protection scope of the present invention.

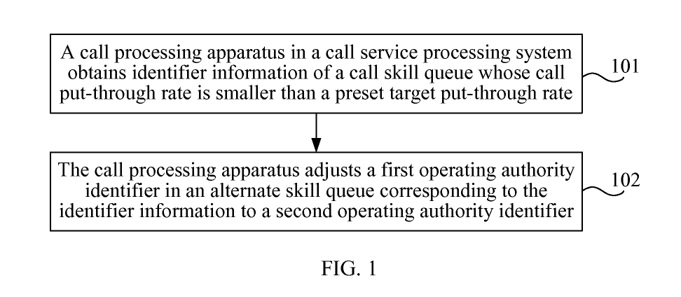

FIG. 1 is a flow chart of an embodiment of a call processing method according to the present invention, and as shown in FIG. 1, the method according to the embodiment may include:

Step 101: A call processing apparatus in a call service processing system obtains identifier information of a call skill queue whose call put-through rate is smaller than a preset target put-through rate.

For example, in the embodiment, the call service processing system may be a CC, and the call processing apparatus may be a call processing apparatus set outside the CC or a call processing apparatus set inside the CC. The call processing apparatus may obtain identifier information of a call skill queue whose call put-through rate is smaller than a preset target put-through rate in real time or regularly.

Specifically, for attributes such as different areas, customer values and service contents the CC may set different call skill queues, for example, a gold card customer complaint skill queue, a gold card customer service consulting skill queue, a silver card customer complaint skill queue and a silver card customer data service skill queue. The CC may allocate different skill queue authority according to service proficiency and service skills of operators. An operator may have operating authority of multiple call skill queues at the same time, and a highly-skilled operator may be allocated to a call skill queue of high-value customers. It should be noted that, the embodiment does not limit division of call skill queues.

After a customer sets up a call with the CC, the CC may obtain customer information, such as a customer level and a home location, by invoking a customer data interface, and in combination with a type, for example service types such as complaint, consulting and handling, for which the customer switches to the operator service in an IVR automatic service process, the CC may route the call to a corresponding call skill queue to perform corresponding service processing.

The number of calls to be processed at the same time is large, and the number of the operators is very limited, therefore during a call peak, the call put-through rate of the call skill queue is often lower than the target put-through rate, thus deteriorating quality of service. In this case, according to the embodiment, the number of serving operators in a call skill queue is dynamically adjusted, so as to effectively increase a utilization rate of the operators and increase the call put-through rate. The call processing apparatus may monitor call put-through rates of all call skill queues, and obtain identifier information of a call skill queue whose call put-through rate is smaller than a preset target put-through rate among all call skill queues. For example, the CC has 10 call skill queues totally, and identifier information of the call skill queues is set to 1 to 10 respectively. The call processing apparatus set inside or outside the CC may obtain current call put-through rates of the 10 call skill queues. If a call put-through rate of the third call skill queue is lower than a preset target put-through rate, the call processing apparatus obtains identifier information 3 of the third call skill queue, so that the call processing apparatus may determine the third call skill queue as a call skill queue to be processed.

It should be noted that, the embodiment does not limit the number of the call skill queues, and the identifier information may employ any implementation manner.

Step 102: The call processing apparatus adjusts a first operating authority identifier in an alternative skill queue corresponding to the identifier information to a second operating authority identifier.

The first operating authority identifier is an operating authority identifier of a remaining free operator of the alternative skill queue on the basis of ensuring the target put-through rate. The second operating authority identifier is an operating authority identifier that can process the call skill queue.

In the embodiment, each call skill queue may be configured with at least one alternative skill queue correspondingly. The alternative skill queue may provide the call skill queue with an operator that may be adjusted to the call skill queue to perform service processing. Further, service types that can be processed by the alternative skill queue are the same as types processed by the call skill queue. For example, for a call skill queue that processes a data service, an alternative skill queue of the call skill queue can also process a corresponding data service. A correlation exists between the call skill queue and a corresponding alternative skill queue of the call skill queue. In the embodiment, the correlation may be a correlation between identifier information of the call skill queue and identifier information of the alternative skill queue of the call skill queue, which is not limited in the embodiment.

After obtaining the identifier information of the call skill queue whose call put-through rate is lower than the preset target put-through rate, the call processing apparatus may determine a corresponding alternative skill queue according to the identifier information, determine a first operating authority identifier in the alternative skill queue, where the first operating authority identifier corresponds to a free operator in the alternative skill queue, and adjust the first operating authority identifier to a second operating authority identifier, so that the free operator corresponding to the adjusted operating authority identifier can process a call of the current call skill queue with a lower call put-through rate. Therefore, when determining which operating authority identifiers in the alternative skill queue are first operating authority identifiers, that is, which operators are free operators, the call processing apparatus needs to ensure that after these free operators are adjusted to the call skill queue, the call put-through rate of the alternative skill queue can still reach the corresponding target put-through rate of the alternative skill queue. For example, an alternative skill queue of a call skill queue of a Shenzhen ordinary customer data service may be a call skill queue of a Shenzhen gold card data service, a call skill queue of a Shenzhen silver card data service, a call skill queue of a Guangzhou gold card data service and a call skill queue of a Guangzhou silver card data service. When the call processing apparatus monitors and obtains a current call put-through rate of the call skill queue of the Shenzhen ordinary customer data service is 80%, which is smaller than a corresponding target put-through rate 85% of the call skill queue, the call processing apparatus may obtain identifier information of the call skill queue of the Shenzhen ordinary customer data service, so as to determine that alternative skill queues corresponding to the identifier information are the call skill queue of the Shenzhen gold card data service, the call skill queue of the Shenzhen silver card data service, the call sill queue of the Guangzhou gold card data service and the call skill queue of the Guangzhou silver card data service. Therefore, the call processing apparatus may adjust first operating authority identifiers of free operators, where operators corresponding to representatives in the alternative skill queues are the free operators, to second operating authority identifiers that can process the call skill queue, thus increasing the call put-through rate of the call skill queue that requires supplemental operators on the basis of ensuring that the call put-through rates of the alternative skill queues can reach the target put-through rates.

It should be noted that the embodiment does not limit the specific implementation manner in which the first operating authority identifier is adjusted to the second operating authority identifier, if only the free operator in the alternative skill queue may process the service of the call skill queue.

In the embodiment, a corresponding alternative skill queue may be preset for each call skill queue. When the call put-through rate of the call skill queue is smaller than the preset target put-through rate, the first operating authority identifier in the alternative skill queue may be adjusted to the second operating authority identifier, so that the operator corresponding to the adjusted operating authority identifier can listen to the call put-through rate of the call skill queue currently required to be adjusted, and the call put-through rate of the alternative skill queue is not affected. In the embodiment, the call skill queue of high-value customers and that of customers of a lower value do not need to be distinguished, and instead, under the precondition that the target put-through rate of the alternative skill queue is ensured, all call skill queues are dynamically adjusted. Therefore, according to the embodiment of the present invention, the operator may be taken full advantage of to improve quality of service of all call skill queues.

During the specific implementation process, when the call processing apparatus monitors the call put-through rate of each call skill queue, the number of call skill queues whose call put-through rates are small than the target put-through rates may be one or more. The technical solutions of the call processing method according to the present invention are described below in detail through specific embodiments.

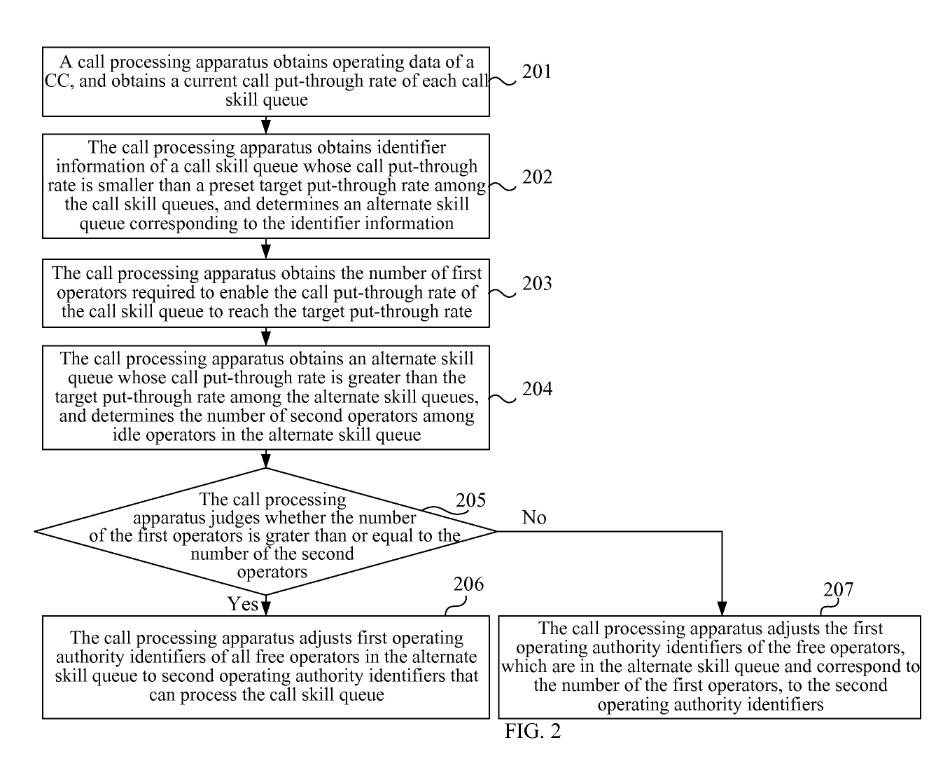

FIG. 2 is a flow chart of another embodiment of the call processing method according to the present invention, and as shown in FIG. 2, the method according to the embodiment may include:

Step 201: A call processing apparatus obtains operating data of a CC, and obtains a current call put-through rate of each call skill queue.

For example, the call processing apparatus may obtain the operating data of the CC at regular times by invoking a configuration monitoring interface, refresh the data, and buffer the data locally. Persons skilled in the art may set time intervals between the regular times according to requirements on adjustment frequency. Through the operating data, the call processing apparatus may obtain the current call put-through rate of each call skill queue. It should be noted that, in the embodiment, the call processing apparatus may monitor all call skill queues in the CC, and may also monitor part of call skill queues in the CC. For example, only call skill queues of high-value customers are monitored.

Step 202: The call processing apparatus obtains identifier information of a call skill queue whose call put-through rate is smaller than a preset target put-through rate among the call skill queues, and determines an alternative skill queue corresponding to the identifier information.

In the embodiment, the number of call skill queues whose current call put-through rates are smaller than the preset target put-through rates may be set to one, and accordingly, the call processing apparatus may only obtain the identifier information of the call skill queue. Further, the call processing apparatus may determine the corresponding alternative skill queue according to the identifier information. For example, the identifier information may be identifier information indicating a data service type, where the alternative skill queue is a call skill queue related to the data service type. In the embodiment, the number of alternative skill queues corresponding to the identifier information may be one or more.

In the embodiment, target put-through rates corresponding to different call skill queues may be the same or different. Specifically, the call processing apparatus may compare the current call put-through rate of each call skill queue with the preset target put-through rate corresponding to each call skill queue one by one respectively, so as to determine which call skill queues among the call skill queues have the call put-through rates being smaller than the target put-through rates.

Step 203: The call processing apparatus obtains the number of first operators required to enable the call put-through rate of the call skill queue to reach the target put-through rate.

For example, the call processing apparatus may obtain current call intensity, the number of current operators and average call duration of the call skill queue through the operating data. Then, according to the obtained call intensity, the number of the current operators and the average call duration, the call processing apparatus may employ an ErLang C formula to calculate and obtain the number of the operators required to enable the call put-through rate of the call skill queue to reach the target put-through rate, and then deduct the number of the current operators from the number of the operators, so as to obtain the number of supplemental operators required to enable the call put-through rate of the call skill queue to reach the target put-through rate, that is, the number of the first operators.

Step 204: The call processing apparatus obtains an alternative skill queue whose call put-through rate is greater than the target put-through rate among the alternative skill queues, and determines the number of second operators among free operators in the alternative skill queue.

In the embodiment, alternative skill queues whose alternative skill queue call put-through rates are smaller than or equal to the target put-through rates among the alternative skill queues do not have any free operator that can be adjusted, therefore in the embodiment, processing is not performed on the alternative skill queues, but only on alternative skill queues whose call put-through rates are greater than the target put-through rates among the alternative skill queues. In the embodiment, an example in which there is only one alternative skill queue whose call put-through rate alternative skill queue is greater than the target put-through rate among the alternative skill queues corresponding to the identifier information.

According to the current call intensity, the number of the current operators and the average call duration of the alternative skill queue, the call processing apparatus may employ the ErLang C formula to calculate the number of the operators required to enable the call put-through rate of the alternative skill queue to reach the target put-through rate, and then compare the number of the operators with the number of the current operators, so as to obtain the number of the second operators, which are among the free operators and may support the call skill queue.

It should be noted that, there may be no sequence order between step 203 and step 204.

Step 205: The call processing apparatus judges whether the number of the first operators is greater than or equal to the number of the second operators. If the number of the first operators is greater than or equal to the number of the second operators, step 206 is executed; if the number of the first operators is smaller than the number of the second operators, step 207 is executed.

Step 206: The call processing apparatus adjusts first operating authority identifiers of all free operators in the alternative skill queue to second operating authority identifiers that can process the call skill queue.

For example, the number of the first operators required by the call skill queue is 7, but the number of the second operators among the free operators that can be supported by the alternative skill queue is 5, so that the number of the free operators in the alternative skill queue is not enough to support the number of the operators required by the call skill queue, and in this case only the first operating authority identifiers corresponding to all free operators, namely 5 operators, in the alternative skill queue may be adjusted to the second operating authority identifiers that can process the call skill queue, thus increasing the call put-through rate of the call skill queue as much as possible at the same time of ensuring the call put-through rate of the alternative skill queue.

Step 207: The call processing apparatus adjusts the first operating authority identifiers of the free operators, which are in the alternative skill queue and correspond to the number of the first operators, to the second operating authority identifiers.

For example, the number of the first operators required by the call skill queue is 5, but the number of the second operators among the free operators that can be supported by the alternative skill queue is 7, so that the number of the free operators in the alternative skill queue is enough to support the number of the operators required by the call skill queue, and in this case 5 operators may be randomly selected from all free operators in the alternative skill queue, that is, the first operating authority identifiers corresponding to the 5 selected operators are adjusted to the second operating authority identifiers that can process the call skill queue, thus not only ensuring the call put-through rate of the alternative skill queue but also ensuring the call put-through rate of the call skill queue to reach the target put-through rate.

In the embodiment, a corresponding alternative skill queue may be preset for each call skill queue. When the call put-through rate of the call skill queue is smaller than the preset target put-through rate, the first operating authority identifiers of all of or part of the operators in the alternative skill queue may be adjusted to the second operating authority identifiers, so that the operators corresponding to the adjusted operating authority identifiers can listen to the call put-through rate of the call skill queue currently required to be adjusted, and the call put-through rate of the alternative skill queue is not affected. In the embodiment of the present invention, the call skill queue of high-value customers and that of customers of a lower value do not need to be distinguished, and instead, under the precondition that the target put-through rate of the alternative skill queue is ensured, all call skill queues are dynamically adjusted. Therefore, according to the embodiment, the operator may be taken full advantage of to improve quality of service of all call skill queues.

FIG. 3 is a flow chart of another embodiment of the call processing method according to the present invention, and as shown in FIG. 3, the method according to the embodiment may include:

Step 301: A call processing apparatus obtains operating data of a CC, and obtains a current call put-through rate of each call skill queue.

For example, the call processing apparatus may obtain the operating data of the CC at regular times by invoking a configuration monitoring interface, refresh the data, and buffer the data locally. Persons skilled in the art may set time intervals between the regular times according to requirements on adjustment frequency. Through the operating data, the call processing apparatus may obtain the current call put-through rate of each call skill queue. It should be noted that, in the embodiment, the call processing apparatus may monitor all call skill queues in the CC, and may also monitor part of call skill queues in the CC. For example, only call skill queues of high-value customers are monitored. In the embodiment, the operating data shown in Table 1 is taken as an example for description.

TABLE 1

| | | | | | | Average | | Deviation |
|---|---|---|---|---|---|---|---|---|
| Call | | Target | Adjustment | | Actual | Call | | Rate of |
| Skill | | Put-through | Threshold | Alternate | Put-through | Duration | Call Intensity | Put-through |
| Queue | Weight | Rate | Value | Skill Queue | Rate | (second) | (number/hour) | Rate |
| Queue A | 10 | 85% | 85% | A1 | 82% | 75 | 4,500 | 3.5% |
| Queue B | 8 | 80% | 75% | B1, B2 | 67% | 80 | 12,000 | 16.25% |
| Queue C | 4 | 70% | 60% | C1, C2, C3 | 55% | 90 | 20,000 | 21.4% |

Step 302: The call processing apparatus obtains identifier information of at least two call skill queues whose call put-through rates are smaller than preset target put-through rates among the call skill queues, and determines alternative skill queues corresponding to the identifier information.

As shown in Table 1, call put-through rates of a call skill queue A, a call skill queue B and a call skill queue C are all smaller than their respective preset target put-through rates, so that the call processing apparatus may obtain identifier information of the three call skill queues, for example, “Queue A”, “Queue B” and “Queue C”. Further, through the identifier information, it may further be determined that an alternative skill queue corresponding to “Queue A” is a queue A1, alternative skill queues corresponding to “Queue B” are queues B1 and B2, and alternative skill queues corresponding to “Queue C” are queues C1, C2 and C3.

Step 303: The call processing apparatus determines a priority order of the call skill queues.

In the embodiment, the call processing apparatus may adjust, according to the priority order of the at least two call skill queues, operating authority of free operators in the alternative skill queues corresponding to the identifier information to operating authority that can process the call skill queues. The priority order includes a customer value priority order and/or a put-through rate deviation priority order. The put-through rate deviation=(the target put-through rate−the call put-through rate)/the target put-through rate.

Specifically, the call skill queues may be preset with different priority orders according to customer values, where customers are served by the call skill queues. For example, the number of the call skill queues whose call put-through rates are smaller than the preset target put-through rates among the call skill queues obtained by the call processing apparatus, is three, and the operating data related to the three call skill queues are as shown in Table 1.

If the current priority order is configured to be a descending customer value priority order, and sequencing is performed according to the deviation of the put-through rate, the adjusted order is: queue A->queue B->queue C (10>8>4); if the current priority order is configured to be that sequencing is performed according to a descending order of the deviation of the put-through rate, and sorting is performed according to a descending customer value priority order, the adjusted order is: queue C->queue B->queue A (21.4>16.25>3.5). The sequencing may also be performed according to an ascending order for the foregoing order. When values of a first priority order of two skill queues are equal, comparison is performed according to values of a second priority order, so as to select a call skill queue of high priority.

In the embodiment, an example in which the priority order is based on the customer value priority order, that is, the weight in Table 1 may be taken for description. Therefore, a processing priority order may be: the call skill queue A, the call skill queue B and the call skill queue C.

Step 304: The call processing apparatus adjusts a first operating authority identifier of a free operator in the alternative skill queue A1 corresponding to the call skill queue A to a second operating authority identifier.

A specific implementation process of step 304 is similar to the implementation process of steps 203 to 207 in FIG. 2, which is not repeatedly described here.

Step 305: The call processing apparatus adjusts first operating authority identifiers of free operators in the alternative skill queues B1 and B2 that correspond to the call skill queue B to second operating authority identifiers.

Specifically, the call processing apparatus may first judge whether respective call put-through rates of the alternative skill queues B1 and B2 are greater than the target put-through rate. If the respective call put-through rates of the alternative skill queues B1 and B2 are greater than the target put-through rate, it indicates that adjustable free operators exist in the alternative skill queues. If the respective call put-through rates of the alternative skill queues B1 and B2 are smaller than or equal to the target put-through rate, it indicates that no adjustable free operator exists in the alternative skill queues. Therefore, in the embodiment, it may be assumed that the call put-through rate of the alternative skill queue B1 is smaller than or equal to the target put-through rate, and the call put-through rate of the alternative skill queue B2 is greater than the target put-through rate. Therefore, the alternative skill queue B2 may provide support for the call skill queue B.

A specific implementation process of adjusting the first operating authority identifier of a free operator in the alternative skill queue B2 to the second operating authority identifier that can process the call skill queue is similar to the implementation process of steps 203 to 207 in FIG. 2, which is not repeatedly described here.

Step 306: The call processing apparatus adjusts first operating authority identifiers of free operators in the alternative skill queues C1, C2 and C3 that correspond to the call skill queue C to second operating authority identifiers.

Specifically, the call processing apparatus may first judge whether respective call put-through rates of the alternative skill queues C1, C2 and C3 are greater than the target put-through rate. If the respective call put-through rates of the alternative skill queues C1, C2 and C3 are greater than the target put-through rate, it indicates that adjustable free operators exist in the alternative skill queues. If the respective call put-through rates of the alternative skill queues C1, C2 and C3 are smaller than or equal to the target put-through rate, it indicates that no adjustable free operator exists in the alternative skill queues. Therefore, in the embodiment, it may be assumed that the respective call put-through rates of the alternative skill queues C1, C2 and C3 are all greater than the corresponding target put-through rate corresponding to the alternative skill queues C1, C2 and C3, so that the alternative skill queues C1, C2 and C3 may all provide support for the call skill queue C.

When at least two alternative skill queues that provide support for the call skill queue exist at the same time, the process of adjusting the first operating authority identifiers in the alternative skill queues to the second operating authority identifiers in step 306 may be:

obtaining the number of first operators required to enable the call put-through rate of the call skill queue to reach the target put-through rate; determining at least two alternative skill queues alternative skill queue whose call put-through rates are greater than the target put-through rate among the alternative skill queues corresponding to the identifier information; determining the numbers of third operators among free operators, where the numbers of third operators respectively correspond to the at least two alternative skill queues; adjusting the first operating authority identifiers in the at least two alternative skill queues to the second operating authority identifiers by applying an average allocation manner if the sum of the numbers of the third operators of the at least two alternative skill queues is greater than the number of the first operators; and adjusting all of the first operating authority identifiers in the at least two alternative skill queues to the second operating authority identifiers if the sum of the numbers of the third operators of the at least two alternative skill queues is smaller than or equal to the number of the first operators.

By taking Table 1 as an example, the call processing apparatus may calculate, according to the ErLang C formula, the number of the first operators M required to enable the call put-through rate of the call skill queue to reach the target put-through rate. In the embodiment, it may be assumed that the number of the first operators M is 20, and the numbers of the operators required to enable the alternative skill queues C1, C2 and C3 to reach the target put-through rate of the alternative skill queues C1, C2 and C3 may also be calculated according to the ErLang C formula. The numbers of the operators required to satisfy the target put-through rate are compared with the numbers of the current operators in the alternative skill queues, so as to obtain the numbers of the operators, N1, N2 and N3, that support the call skill queue C respectively, that is, the numbers of the third operators, where the values of N1, N2 and N3 are greater than or equal to 0. It can be known that the comparison between the value of N1+N2+N3 and the value of M includes two situations.

One is that N1+N2+N3≦M. In the situation, the numbers of the operators, which are in the alternative skill queues C1, C2 and C3 and with the actually adjustable operating authority, are N1, N2 and N3 correspondingly. That is, the sum of the numbers of the free operators in the alternative skill queues C1, C2 and C3 is not enough to support the number of the operators required by the call skill queue. Therefore, in this case, the first operating authority identifiers corresponding to all free operators in the alternative skill queues, that is, the N1+N2+N3 operators have to be adjusted to the second operating authority identifiers that can process the call skill queue, thus increasing the call put-through rate of the call skill queue as much as possible at the same time of ensuring the call put-through rates of the alternative skill queues.

The other is that N1+N2+N3>M. In the situation, the numbers of the operators, T1, T2 and T3, required to be adjusted in the alternative skill queues may be determined by the average allocation manner. That is, allocation is performed according to the average number required for adjustment for each alternative skill queue. If an alternative skill queue that does not reach the average number exists, re-allocation is performed through remaining skill queues. For example, when M=20, N1=10, N2=3 and N3=13, T1=8, T2=3 and T3=9.

In the embodiment, a corresponding alternative skill queue may be preset for each call skill queue. When the call put-through rate of the call skill queue is smaller than the preset target put-through rate, the first operating authority identifiers of all of or part of the operators in the alternative skill queue may be adjusted to the second operating authority identifiers, so that the operators corresponding to the adjusted operating authority identifiers can listen to the call put-through rate of the call skill queue currently required to be adjusted, and the call put-through rate of the alternative skill queue is not affected. In the embodiment of the present invention, the call skill queue of high-value customers and that of customers of a lower value do not need to be distinguished, and instead, under the precondition that the target put-through rate of the alternative skill queue is ensured, all call skill queues are dynamically adjusted. Therefore, according to the embodiment, the operator may be taken full advantage of to improve quality of service of all call skill queues, thus effectively ensuring the call put-through rates of the call skill queues in the CC and customer satisfaction. Operating authority of the operators in the relatively-idle call skill queue is automatically monitored, identified, and adjusted to process calls of a call skill queue with heavy call traffic and a low call put-through rate, so as to not only effectively increase the call put-through rate of the call skill queue, but also effectively ensure relatively balanced work of the operators, thus avoiding the problem that operators of some call skill queues are very busy and operators of some call skill queues are very free.

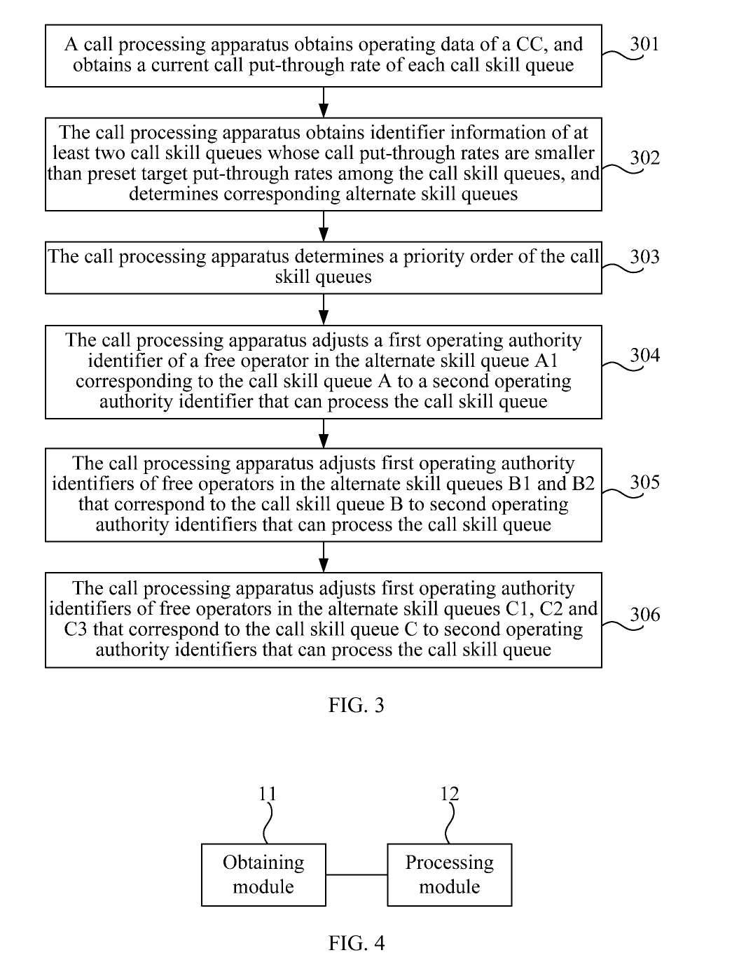

FIG. 4 is a schematic structural diagram of an embodiment of a call processing apparatus according to the present invention. As shown in FIG. 4, the apparatus according to the embodiment may include: an obtaining module 11 and a processing module 12. The obtaining module 11 is configured to obtain identifier information of a call skill queue whose call put-through rate is smaller than a preset target put-through rate. The processing module 12 adjusts a first operating authority identifier of a free operator in an alternative skill queue corresponding to the identifier information to a second operating authority identifier. The first operating authority identifier is an operating authority identifier of a remaining free operator of the alternative skill queue on the basis of ensuring the target put-through rate. The second operating authority identifier is an operating authority identifier that can process the call skill queue.

The apparatus according to the embodiment may be configured to execute the call processing method shown in FIG. 1, and implementation principles of the apparatus according to the embodiment are similar to those of the call processing method, which are not repeatedly described here.

The apparatus according to the embodiment may preset a corresponding alternative skill queue for each call skill queue. When the call put-through rate of the call skill queue is smaller than the preset target put-through rate, the first operating authority identifiers of all of or part of the operators in the alternative skill queue may be adjusted to the second operating authority identifiers, so that the operators corresponding to the adjusted operating authority identifiers can listen to the call put-through rate of the call skill queue currently required to be adjusted, and the call put-through rate of the alternative skill queue is not affected. In the embodiment of the present invention, the call skill queue of high-value customers and that of customers of a lower value do not need to be distinguished, and instead, under the precondition that the target put-through rate of the alternative skill queue is ensured, all call skill queues are dynamically adjusted. Therefore, according to the embodiment, the operator may be taken full advantage of to improve quality of service of all call skill queues.

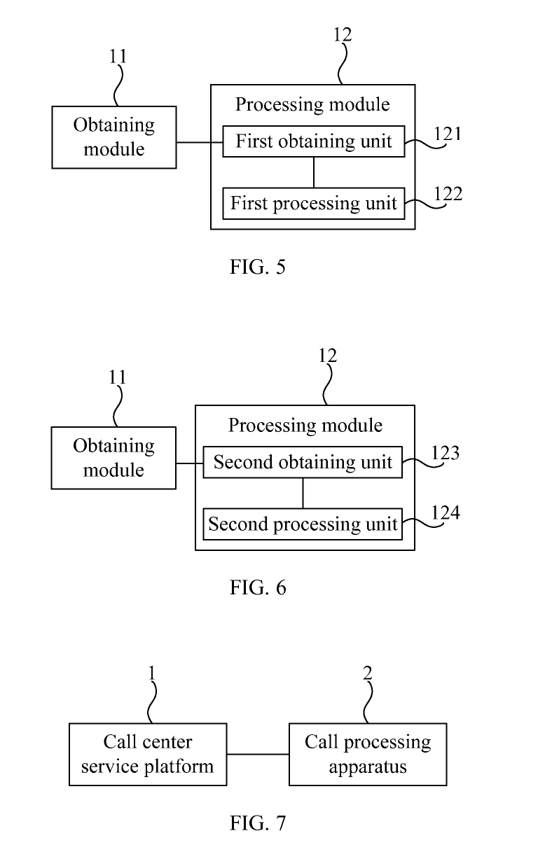

FIG. 5 is a schematic structural diagram of another embodiment of the call processing apparatus according to the present invention. As shown in FIG. 5, in the apparatus according to the embodiment, based on the apparatus shown in FIG. 4, further, the obtaining module 11 is specifically configured to obtain identifier information of at least two call skill queues whose call put-through rates are smaller than preset target put-through rates. The processing module 12 is specifically configured to adjust first operating authority identifiers in alternative skill queues corresponding to the identifier information to second operating authority identifiers according to a priority order of the at least two call skill queues. The processing module 12 may include: a first obtaining unit 121 and a first processing unit 122. The first obtaining unit 121 is configured to obtain the number of first operators required to enable the call put-through rate of the call skill queue to reach the target put-through rate. The first processing unit 122 is configured to determine the number of second operators among free operators in the alternative skill queue if the call put-through rate of the alternative skill queue is greater than the target put-through rate; adjust all first operating authority identifiers in the alternative skill queue to second operating authority identifiers if the number of the first operators is greater than or equal to the number of the second operators; and adjust first operating authority identifiers, which are in the alternative skill queue and correspond to the number of the first operators, to second operating authority identifiers if the number of the first operators is smaller than the number of the second operators.

The apparatus according to the embodiment may be configured to execute the call processing method shown in FIG. 2, and implementation principles of the apparatus according to the embodiment are similar to those of the call processing method, which are not repeatedly described here.

The apparatus according to the embodiment may preset a corresponding alternative skill queue for each call skill queue. When the call put-through rate of the call skill queue is smaller than the preset target put-through rate, the first operating authority identifiers of all of or part of the operators in the alternative skill queue may be adjusted to the second operating authority identifiers, so that the operators corresponding to the adjusted operating authority identifiers can listen to the call put-through rate of the call skill queue currently required to be adjusted, and the call put-through rate of the alternative skill queue is not affected. In the embodiment of the present invention, the call skill queue of high-value customers and that of customers of a lower value do not need to be distinguished, and instead, under the precondition that the target put-through rate of the alternative skill queue is ensured, all call skill queues are dynamically adjusted. Therefore, according to the embodiment, the operator may be taken full advantage of to improve quality of service of all call skill queues.

FIG. 6 is a schematic structural diagram of another embodiment of the call processing apparatus according to the present invention. As shown in FIG. 6, in the apparatus according to the embodiment, based on the apparatus shown in FIG. 4, further, the obtaining module 11 is specifically configured to obtain identifier information of at least two call skill queues whose call put-through rates are smaller than preset target put-through rates. The processing module is specifically configured to adjust, according to a priority order of the at least two call skill queues, operating authority of free operators in the alternative skill queues corresponding to the identifier information to operating authority that can process the call skill queue. The processing module 12 may include a second obtaining unit 123 and a second processing unit 124. The second obtaining unit 123 is configured to obtain the number of first operators required to enable the call put-through rate of the call skill queue to reach the target put-through rate. The second processing unit 124 is configured to determine at least two alternative skill queues whose call put-through rates are greater than the target put-through rates among the alternative skill queues corresponding to the identifier information; determine the numbers of third operators among free operators respectively corresponding to the at least two alternative skill queues; adjust the first operating authority identifiers in the at least two alternative skill queues to the second operating authority identifiers by applying an average allocation manner if the sum of the numbers of the third operators of the at least two alternative skill queues is greater than the number of the first operators; and adjust all of the first operating authority identifiers in the at least two alternative skill queues to the second operating authority identifiers if the sum of the numbers of the third operators of the at least two alternative skill queues is smaller than or equal to the number of the first operators.

The apparatus according to the embodiment may be configured to execute the call processing method shown in FIG. 3, and implementation principles of the apparatus according to the embodiment are similar to those of the call processing method, which are not repeatedly described here.

The apparatus according to the embodiment may preset a corresponding alternative skill queue for each call skill queue. When the call put-through rate of the call skill queue is smaller than the preset target put-through rate, the first operating authority identifiers of all of or part of the operators in the alternative skill queue may be adjusted to the second operating authority identifiers, so that the operators corresponding to the adjusted operating authority identifiers can listen to the call put-through rate of the call skill queue currently required to be adjusted, and the call put-through rate of the alternative skill queue is not affected. In the embodiment of the present invention, the call skill queue of high-value customers and that of customers of a lower value do not need to be distinguished, and instead, under the precondition that the target put-through rate of the alternative skill queue is ensured, all call skill queues are dynamically adjusted. Therefore, according to the embodiment, the operator may be taken full advantage of to improve quality of service of all call skill queues, thus effectively ensuring the call put-through rates of the call skill queues in the CC and customer satisfaction. Operating authority of the operators in the relatively-idle call skill queue is automatically monitored, identified, and adjusted to process calls of a call skill queue with heavy call traffic and a low call put-through rate, so as to not only effectively increase the call put-through rate of the call skill queue, but also effectively ensure relatively balanced work of the operators, thus avoiding the problem that operators of some call skill queues are very busy and operators of some call skill queues are very free.

FIG. 7 is a schematic structural diagram of an embodiment of a call service processing system according to the present invention. As shown in FIG. 7, the system according to the embodiment may include a call center service platform 1 and a call processing apparatus 2. The call center service platform 1 is configured to employ a call skill queue to perform service processing on a call. The call processing apparatus 2 is configured to obtain identifier information of a call skill queue whose call put-through rate is smaller than a preset target put-through rate, and adjust a first operating authority identifier in an alternative skill queue corresponding to the identifier information to a second operating authority identifier. The first operating authority identifier is an operating authority identifier of a remaining free operator of the alternative skill queue on the basis of ensuring the target put-through rate. The second operating authority identifier is an operating authority identifier that can process the call skill queue.

In the system according to the embodiment, the call center service platform 1 may be any existing call center service platform. The call processing apparatus 2 may act as a built-in device of the call center service platform 1 and may also be an external device of the call center service platform. The call processing apparatus 2 may be implemented by adopting any structure in FIG. 4 to FIG. 6, and accordingly configured to execute the call processing method shown in FIG. 1 to FIG. 3, and implementation principles of the call processing apparatus 2 are similar to those of the call processing method, which are not repeatedly described here.

The system according to the embodiment may preset a corresponding alternative skill queue for each call skill queue. When the call put-through rate of the call skill queue is smaller than the preset target put-through rate, the first operating authority identifiers of all of or part of the operators in the alternative skill queue may be adjusted to the second operating authority identifiers, so that the operators corresponding to the adjusted operating authority identifiers can listen to the call put-through rate of the call skill queue currently required to be adjusted, and the call put-through rate of the alternative skill queue is not affected. In the embodiment of the present invention, the call skill queue of high-value customers and that of customers of a lower value do not need to be distinguished, and instead, under the precondition that the target put-through rate of the alternative skill queue is ensured, all call skill queues are dynamically adjusted. Therefore, according to the embodiment, the operator may be taken full advantage of to improve quality of service of all call skill queues, thus effectively ensuring the call put-through rates of the call skill queues in the CC and customer satisfaction. Operating authority of the operators in the relatively-idle call skill queue is automatically monitored, identified, and adjusted to process calls of a call skill queue with heavy call traffic and a low call put-through rate, so as to not only effectively increase the call put-through rate of the call skill queue, but also effectively ensure relatively balanced work of the operators, thus avoiding the problem that operators of some call skill queues are very busy and operators of some call skill queues are very free.

Those of ordinary skill in the art should understand that all or part of the steps of the foregoing method embodiments may be implemented by a program instructing relevant hardware. The program may be stored in a computer readable storage medium. When the program is executed, the steps of the foregoing method embodiments are performed. The storage medium may be any medium that is capable of storing program codes, such as a ROM, a RAM, a magnetic disk, and an optical disk.

Finally, it should be noted that the foregoing embodiments are merely provided for describing the technical solutions of the present invention, but not intended to limit the present invention. Although the present invention is described in detail with reference to the foregoing embodiments, it should be understood by persons of ordinary skill in the art that: Modifications may still be made to the technical solutions described in the foregoing embodiments, or equivalent replacements may be made to some technical features in the technical solutions; however, the modifications or replacements do not cause the essence of corresponding technical solutions to depart from the spirit and scope of the present invention.

Only exemplary embodiments of the present invention are described above. It should be noted that, improvements and modifications may be made by persons of ordinary skill in the art without departing from the principles of the present invention, and the improvements and modifications shall fall within the protection scope of the present invention.

What is claimed is:

1. A call processing method, comprising:
obtaining, by a call processing apparatus, identifier information of a call skill queue whose call put-through rate is smaller than a preset target put-through rate; and
adjusting, by the call processing apparatus, a first operating authority identifier in an alternative skill queue corresponding to the identifier information to a second operating authority identifier, wherein the first operating authority identifier is an operating authority identifier of a remaining free operator of the alternative skill queue on the basis of ensuring the target put-through rate, and the second operating authority identifier is an operating authority identifier that can process the call skill queue.

2. The call processing method according to claim 1, wherein the obtaining, by the call processing apparatus, the identifier information of the call skill queue whose call put-through rate is smaller than the preset target put-through rate comprises:
obtaining, by the call processing apparatus, identifier information of at least two call skill queues whose call put-through rates are smaller than preset target put-through rates;
wherein the adjusting, by the call processing apparatus, the first operating authority identifier in the alternative skill queue corresponding to the identifier information to the second operating authority identifier comprises:
adjusting, by the call processing apparatus, first operating authority identifiers in alternative skill queues corresponding to the identifier information to second operating authority identifiers according to a priority order of the at least two call skill queues.

3. The call processing method according to claim 2, wherein the priority order comprises at least one of a customer value priority order and a put-through rate deviation priority order.

4. The call processing method according to claim 1 wherein the adjusting, by the call processing apparatus, the first operating authority identifiers in the alternative skill queues corresponding to the identifier information to the second operating authority identifiers comprises:
obtaining, by the call processing apparatus, the number of first operators required to enable the call put-through rate of the call skill queue to reach the target put-through rate;
if a call put-through rate of the alternative skill queue is greater than a target put-through rate, determining, by the call processing apparatus, the number of second operators among free operators in the alternative skill queue; and
if the number of the first operators is greater than or equal to the number of the second operators, adjusting, by the call processing apparatus, all of the first operating authority identifiers in the alternative skill queue to the second operating authority identifiers; if the number of the first operators is smaller than the number of the second operators, adjusting, by the call processing apparatus, the first operating authority identifiers, which are in the alternative skill queue and correspond to the number of the first operators, to the second operating authority identifiers.

5. The call processing method according to claim 1 wherein the adjusting, by the call processing apparatus, the first operating authority identifiers in the alternative skill queues corresponding to the identifier information to the second operating authority identifiers comprises:
obtaining, by the call processing apparatus, the number of first operators required to enable the call put-through rate of the call skill queue to reach the target put-through rate;
determining, by the call processing apparatus, at least two alternative skill queues whose call put-through rates are greater than the target put-through rates among the alternative skill queues corresponding to the identifier information;
determining, by the call processing apparatus, the numbers of third operators among free operators respectively corresponding to the at least two alternative skill queues;
if the sum of the numbers of the third operators of the at least two alternative skill queues is greater than the number of the first operators, adjusting, by the call processing apparatus, the first operating authority identifiers in the at least two alternative skill queues to the second operating authority identifiers by applying an average allocation manner; and if the sum of the numbers of the third operators of the at least two alternative skill queues is smaller than or equal to the number of the first operators, adjusting, by the call processing apparatus, all of the first operating authority identifiers in the at least two alternative skill queues to the second operating authority identifiers.

6. A call processing apparatus, comprising:
an obtaining module, configured to obtain identifier information of a call skill queue whose call put-through rate is smaller than a preset target put-through rate; and
a processing module, configured to adjust a first operating authority identifier of a free operator in the alternative skill queue corresponding to the identifier information to a second operating authority identifier, wherein the first operating authority identifier is an operating authority identifier of a remaining free operator of the alternative skill queue on the basis of ensuring the target put-through rate, and the second operating authority identifier is an operating authority identifier that can process the call skill queue.

7. The call processing apparatus according to claim 6, wherein the obtaining module is specifically configured to obtain identifier information of at least two call skill queues whose call put-through rates are smaller than preset target put-through rates, and the processing module is specifically configured to adjust first operating authority identifiers in alternative skill queues corresponding to the identifier information to second operating authority identifiers according to a priority order of the at least two call skill queues.

8. The call processing apparatus according to claim 6 wherein the processing module comprises:
a first obtaining unit, configured to obtain the number of first operators required to enable the call put-through rate of the call skill queue to reach the target put-through rate; and
a first processing unit, configured to determine the number of second operators among free operators in the alternative skill queue if the call put-through rate of the alternative skill queue is greater than the target put-through rate; adjust all first operating authority identifiers in the alternative skill queue to second operating authority identifiers if the number of the first operators is greater than or equal to the number of the second operators; and adjust first operating authority identifiers, which are in the alternative skill queue and correspond to the number of the first operators, to second operating authority identifiers if the number of the first operators is smaller than the number of the second operators.

9. The call processing apparatus according to claim 6 wherein the processing module comprises:
a second obtaining unit, configured to obtain the number of first operators required to enable the call put-through rate of the call skill queue to reach the target put-through rate; and
a second processing unit, configured to determine at least two alternative skill queues whose call put-through rates are greater than the target put-through rates among the alternative skill queues corresponding to the identifier information; determine the numbers of third operators among free operators respectively corresponding to the at least two alternative skill queues; adjust the first operating authority identifiers in the at least two alternative skill queues to the second operating authority identifiers by applying an average allocation manner, if the sum of the numbers of the third operators of the at least two alternative skill queues is greater than the number of the first operators; and adjust all of the first operating authority identifiers in the at least two alternative skill queues to the second operating authority identifiers if the sum of the numbers of the third operators of the at least two alternative skill queues is smaller than or equal to the number of the first operators.

10. A call service processing system, comprising a call center service platform and a call processing apparatus, wherein
the call center service platform is configured to employ a call skill queue to perform service processing on a call; and
the call processing apparatus is configured to obtain identifier information of the call skill queue whose call put-through rate is smaller than a preset target put-through rate, and adjust a first operating authority identifier in an alternative skill queue corresponding to the identifier information to a second operating authority identifier; wherein the first operating authority identifier is an operating authority identifier of a remaining free operator of the alternative skill queue on the basis of ensuring the target put-through rate, and the second operating authority identifier is an operating authority identifier that can process the call skill queue.
